(19) United States
(12) Patent Application Publication
(10) Pub. No.: US 2013/0037583 A1
(43) Pub. Date: Feb. 14, 2013

(54) UNDERWATER DRINKING APPARATUS

(71) Applicant: David M. Graff, Chelsea, MI (US)

(72) Inventor: David M. Graff, Chelsea, MI (US)

(21) Appl. No.: 13/209,059

(22) Filed: Aug. 12, 2011

(51) Int. Cl. B67D 3/00

(52) U.S. Cl. 222/518

(57) ABSTRACT

Underwater drinking apparatus comprises a hollow body with a sidewall between proximal and distal ends, the proximal end of the housing including a fluid passageway functioning as a mouthpiece. A liquid-holding container removably connected to the body enables the liquid to flow from the container and into the hollow body. A piston slideably disposed in the body has a proximal end configured to seal off the fluid passageway. A spring within the body is operative to bias the piston toward the proximal end of the body to seal off the fluid passageway when not in use. The spring is preferably disposed between the distal end of the piston and an end cap threaded to the distal end of the body. A mechanism is coupled to the piston through the body providing a manually operated control enabling a user to move the piston against the spring.

### FIELD OF THE INVENTION

This application relates generally to scuba diving and, in particular, to apparatus which enables a diver to drink fresh water or other beverages under water.

### BACKGROUND OF THE INVENTION

“SCUBA” is an acronym which stands for self-contained underwater breathing apparatus. The term has become generic for a form of underwater diving in which a diver breathes from a tank of compressed gas through a regulator.

Some dives can last hours and, on occasion, the diver may become thirsty. It is not recommended to drink the water surrounding a diver even if fresh due to bacteria or pollutants. As such, various devices to carry drinking water under the surface have been devised.

U.S. Pat. No. 4,398, 533 discloses an underwater drinking device that includes a container with a chamber for holding liquid and a passage leading to the chamber. A valve opens and closes the passage. The container has a pressure compensator for equalizing pressure in the chamber with exterior hydrostatic pressure. Liquid is placed in the chamber, and the diver provides suction on the end of the tube to draw liquid past the valve, then closes the valve. This displaces air from the container for diving.

U.S. Pat. No. 5,524,612 describes a drinking device for divers including a bag in which liquid is contained, a pipe, a cylinder and a pump. The pipe is connected between the bag and the cylinder via the pump. The cylinder is disposed to a mouthpiece received in a diver's mouth and has an inlet and an outlet defined therein and a piston movably engaged therein. A conduit is connected between the mouthpiece and the outlet of the cylinder such that the liquid contained in the bag is pushed into the diver's mouth via the pipe, the cylinder, the outlet and the conduit by operating the piston. A wire connected between the pump and the mouthpiece has an operation button disposed to a distal end thereof received in the mouthpiece such that the liquid is pumped into the diver's mouth by biting of the button by the diver.

The drinking device for divers disclosed in U.S. Pat. No. 5,709,478 includes a bag and a housing for receiving and for protecting the bag. A cylindrical member is engaged through the bag and the housing and includes an outer thread. A nut is engaged with the cylindrical member for securing the bag to the housing. A cap is engaged on the cylindrical member and a sealing ring is engaged between the cap and the cylindrical member for making a water tight seal. A ferrule is engaged with the cylindrical member and includes an annular flange for engaging with the cap and for retaining the cap in place. A sleeve may be secured to a snorkel assembly. The housing includes a pair of curved panels for engaging with the sleeve and for securing the housing to the sleeve.

Some underwater drinking apparatus are coupled to masks or regulators. The drinking device for a diver described in U.S. Pat. No. 6,758,213 can be mounted in a helmet or in a hollow-nasal mask mounted on the helmet. The drinking device includes a supply line which can be connected to a mouth piece within the helmet or mask to supply liquid under a slight pressure. In addition, a stopper arrangement is provided for regulating a flow of liquid through the supply line to the mouth piece. This stopper arrangement may be controlled manually by the diver.

Other devices exist, including commercially available products. Deep Sea Supply of Pasadena, Ca and other offer “camel back” type hydration bags for underwater use, which simply take the form of a finable bladder connected to a mouthpiece through a hose. The Deep Sea unit has a split membrane in the mouthpiece which separates when the user bites down on it. As a further alternative, some divers simply carry commercially available water bottles down with them and suck out the water while diving.

While solutions such as those described offer different degrees of success, some are too complex whiles others are difficult to clean. Thus, the need still remains for an economical, easy-to-use underwater drinking apparatus.

### SUMMARY OF THE INVENTION

This invention resides in underwater drinking apparatus enabling a scuba diver to consume water or another liquid while diving. The apparatus comprises a hollow body with a sidewall between proximal and distal ends, the proximal end of the housing including a fluid passageway functioning as a mouthpiece. A liquid-holding container removably connected to the body enables the liquid to flow from the container and into the hollow body. A piston slideably disposed in the body has a proximal end configured to seal off the fluid passageway. A spring within the body is operative to bias the piston toward the proximal end of the body to seal off the fluid passageway when not in use. The spring is preferably disposed between the distal end of the piston and an end cap threaded to the distal end of the body.

A mechanism is coupled to the piston through the body providing a manually operated control enabling a user to move the piston against the spring. This action opens the fluid passageway so that the user can draw liquid from the container through the hollow body. In accordance with one preferred embodiment, the mechanism includes a rod coupled to the distal end of the piston and extending through the distal end of the body to a manually graspable member. Alternatively, the mechanism may include a rod or lever coupled to the piston through the sidewall of the body to a manually operable member. The mechanism coupled to the piston may penetrate through the body through an o-ring or other water-tight seal. The liquid-holding container may be rigid or semi-rigid, causing the user to suck more on the mouthpiece to receive liquid, or pliable so that it may be squeezed or collapse more easily during use.

### BRIEF DESCRIPTION OF THE DRAWINGS

FIG. 1 is a somewhat simplified rendering of the invention excluding manual operation apparatus;

FIG. 2 is a simplified cross section of a preferred embodiment of the invention showing a manually operated handle;

FIG. 3 is a drawing which shows a manually operated ring and other possible modifications;

FIG. 4 illustrates the use of a lever coupled to an internal piston; and

FIG. 5 illustrates an alternative pushbutton mechanism.

### DETAILED DESCRIPTION OF THE INVENTION

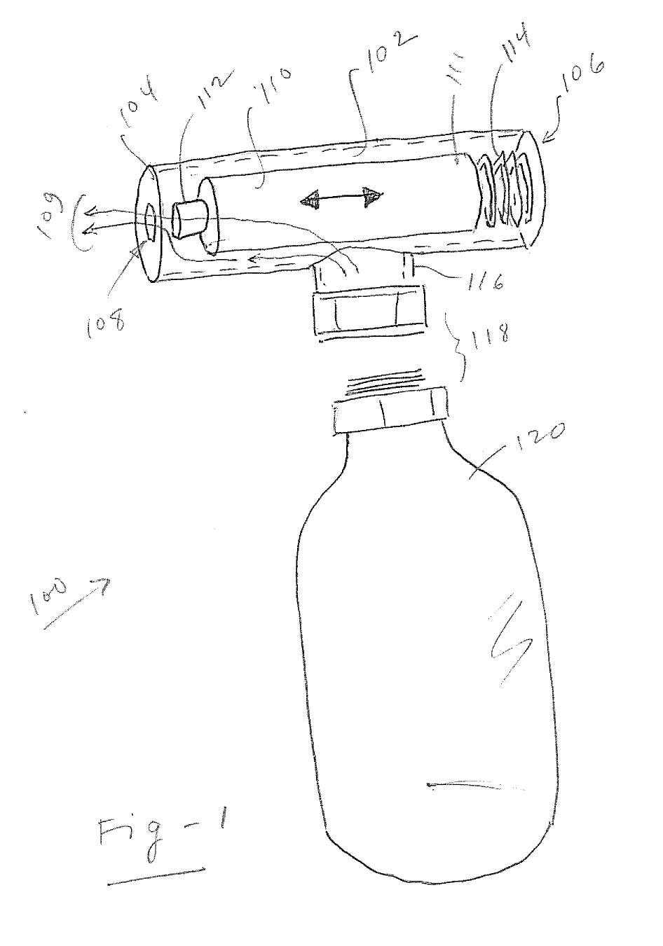

FIG. 1 is a drawing that shows components associated with the preferred embodiments of this invention, but excluding manually operated controls, which will be described with reference to subsequent drawings. The basic apparatus, depicted generally at 100, includes a hollow body 102, preferably cylindrical in shape, having a proximal end 104 with a fluid passageway 108 thereby forming a mouthpiece through which a user (not shown) draws liquid 109 through a container 120.

Within the body 102 is disposed a slug or piston 110 having a proximal end which seals off the fluid passageway 108 and a distal end 111 which is biased away from the distal end 106 of the body 102 through a spring 114. While the proximal end of the piston 110 may simply include a flat surface, in the preferred embodiment, a projection 112 is used which engages with the passageway 108 to form a more satisfying seal.

The liquid-containing container 120, which may be rigid, semi-rigid, or pliable, is removably attached to the body 102 through a threaded connection 118, for example. Until the user is ready to drink the liquid, the piston 110 is biased toward the mouthpiece through spring 114, closing off the passageway, thereby preventing the flow of liquid. To drink from the container 120, a user places their mouth on proximal end 104 of the body 102, and uses one of the mechanisms described below to move the piston 110 against spring 114, thereby opening up passageway 108, enabling liquid 109 to flow from the container 120 past piston 110, and through the body 102. To enable the liquid to flow past the piston 110, the outer diameter of the piston may be less than the inner diameter of the body 102 or, alternatively, the outer surface of piston 110 may include the elongate ridges such that the piston 110 moves back and forth smoothly within the body, while allowing liquid to flow out the mouthpiece. As a further alternative, the piston may be hollow and perforated to allow liquid to flow into the piston and out the mouthpiece.

In terms of construction, the body and piston may be composed of any suitable materials such as metal or plastic. The spring 114 is preferably stainless steel to prevent rusting. The coupling 118 may be plastic or metal, also preferably stainless steel, while the container 120 may be of any suitable plastic or nonbreakable material.

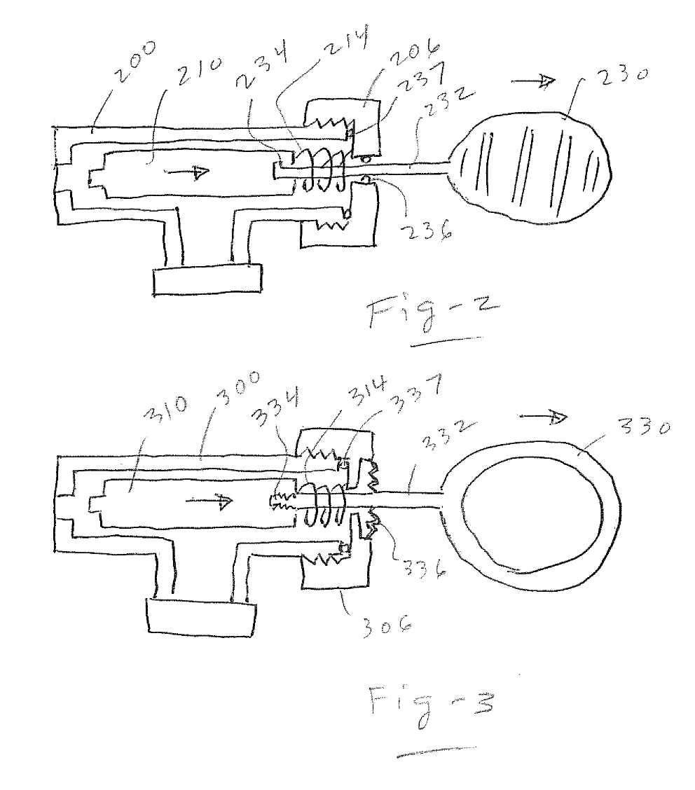

FIG. 2 is a simplified cross-sectional drawing showing a preferred mechanism enabling a user to move the piston and facilitate the flow of liquid. As in FIG. 1 and the other drawings, features are not necessarily shown to scale. In FIG. 2, a manually graspable structure 230 is coupled to piston 210 through a rod 232. The rod, in turn, may be attached to the piston 210 through a keyed coupling 234 or, alternatively, through a threaded connection 334 shown in FIG. 3. The manually graspable structure 230 may be of any suitable shape, such as a flat paddle shape shown, or a ring 330 as shown in FIG. 3.

The rod 232 coupled to the piston 210 preferably penetrates through a threaded end cap 206, which may use an o-ring 237 or other seal to provide a water-tight connection. An O-ring 236 or other seal may be used between the rod 232 and the aperture through the end cap 206.

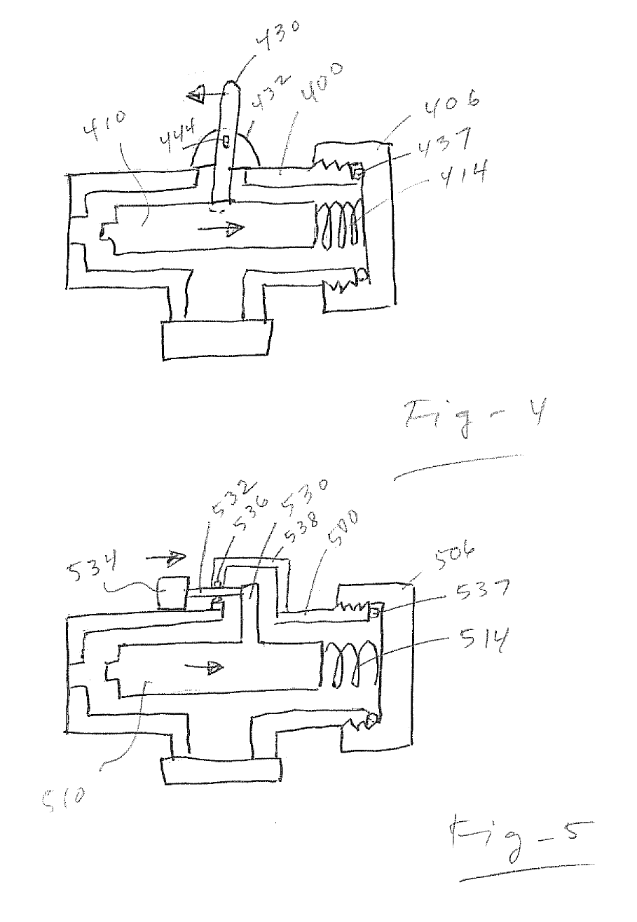

FIG. 3 shows a different type of sealing mechanism between a rod 332 and an end cap 306, namely, a series of concentric rings 336 forming an accordion structure enabling the user to pull piston 310 backward against spring 314 within housing 300 with a truly water-tight structure. Again, however, an O-ring or other seal 337 may be used between cap 306 and body 300. FIG. 4 illustrates an alternative piston-movement mechanism, notably a lever 430 pivotably coupled to piston 410 through axis 444 provided by structure 432 connected to body 400. In this case, movement of the lever 430 proximally causes the piston 410 to move distally against spring 414. In this case, a simple end cap 406 may be provided with an O-ring 437 or other seal.

FIG. 5 shows yet a further alternative piston-movement mechanism, in this case, a structure 530 extending from piston 510 through an opening or slot in body 500. The structure 530 is coupled or rigidly connected to a rod 532 which, in turn, is coupled or connected to a pushbutton 534. The rod 532 extends into a housing 538 attached to the outer wall of the body 500 through a seal 536, to prevent ambient water from entering into the mechanism. As with the embodiment of FIG. 4, a simple end cap 506 may be sealed to body 500 through an O-ring 537 to provide a distal end against which spring 514 biases piston 510 toward the mouthpiece.

I claim:

1. Underwater drinking apparatus, comprising:
a hollow body having a sidewall between proximal and distal ends, the proximal end of the housing including a fluid passageway functioning as a mouthpiece;
a liquid-holding container removably connected to the body such that the liquid is able to flow from the container and into the hollow body;
a piston in the body, the piston having a proximal end configured to seal off the fluid passageway;
a spring disposed within the hollow body between the distal end of the piston and the distal end of the body, the spring being operative to bias the piston toward the proximal end of the body to seal off the fluid passageway; and
a mechanism coupled to the piston through the body providing a manually operated control enabling a user to move the piston against the spring, thereby opening the fluid passageway so that the user can draw liquid from the container through the hollow body.

2. The underwater drinking apparatus of claim 1, wherein the mechanism includes a rod coupled to the distal end of the piston and extending through the distal end of the body to a manually graspable member.

3. The underwater drinking apparatus of claim 1, wherein the mechanism includes a rod or lever coupled to the piston through the sidewall of the body to a manually operable member.

4. The underwater drinking apparatus of claim 1, wherein the spring is disposed between the distal end of the piston and an end cap threaded to the distal end of the body.

5. The underwater drinking apparatus of claim 1, wherein the mechanism coupled to the piston penetrates the body through an o-ring or other water-tight seal.

6. The underwater drinking apparatus of claim 1, wherein the liquid-holding container is rigid, semi-rigid or pliable.

7. The underwater drinking apparatus of claim 1, wherein the liquid-holding container is removably connected to the body through a threaded connection.

8. The underwater drinking apparatus of claim 1, wherein the hollow body is generally cylindrical.
